(19) United States
(12) Patent Application Publication
(10) Pub. No.: US 2025/0149651 A1
(43) Pub. Date: May 8, 2025

(54) ANODE ELECTRODE FOR SEMI-SOLID STATE BATTERY CELLS

(71) Applicant: GM GLOBAL TECHNOLOGY OPERATIONS LLC, Detroit, MI (US)

(72) Inventors: Jeffrey David CAIN, Royal Oak, MI (US); Yifan ZHAO, Troy, MI (US); Yun-Yu LAI, Clawson, MI (US); Thomas A. YERSAK, Royal Oak, MI (US); Zhe LI, Shanghai (CN); Fang DAI, Troy, MI (US)

(21) Appl. No.: 18/641,883

(22) Filed: Apr. 22, 2024

(30) Foreign Application Priority Data
Nov. 8, 2023 (CN) 202311481808.1

(51) Int. Cl. H01M 10/42; H01M 4/38; H01M 4/58; H01M 10/052; H01M 10/0562; H01M 10/0568; H01M 10/058; H01M 50/383

(52) U.S. Cl. CPC H01M 10/4235; H01M 4/386; H01M 4/5815; H01M 10/052; H01M 10/0562; H01M 10/0568; H01M 10/058; H01M 50/383; H01M 2300/0025; H01M 2300/0071

(57) ABSTRACT

A battery cell includes an enclosure and a battery cell stack including C cathode electrodes each comprising a cathode active material layer arranged on a cathode current collector, S separators, and A anode electrodes each comprising an anode active material layer arranged on an anode current collector, wherein A, C, and S are integers greater than one. The anode active material layer includes an anode active material selected from a group consisting of silicon, silicon oxide, silicon alloy, and tin, a solid-state electrolyte comprising an oxysulfide, a conductive additive, and a binder. An electrolyte includes a solvate ionic liquid.

### CROSS-REFERENCE TO RELATED APPLICATIONS

This application claims the benefit of Chinese Patent Application No. 202311481808.1, filed on Nov. 8, 2023. The entire disclosure of the application referenced above is incorporated herein by reference.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to battery cells, and more particularly to anode electrodes for semi-solid state battery cells.

Electric vehicles (EVs) such as battery electric vehicles (BEVs), hybrid vehicles, and/or fuel cell vehicles include one or more electric machines and a battery system including one or more battery cells, modules and/or packs. A battery control module is used to control charging and/or discharging of the battery system during charging and/or driving. Manufacturers of EVs are pursuing increased power density to increase the range of the EVs.

### SUMMARY

A battery cell includes an enclosure and a battery cell stack including C cathode electrodes each comprising a cathode active material layer arranged on a cathode current collector, S separators, and A anode electrodes each comprising an anode active material layer arranged on an anode current collector, wherein A, C, and S are integers greater than one. The anode active material layer includes an anode active material selected from a group consisting of silicon, silicon oxide, silicon alloy, and tin, a solid-state electrolyte comprising an oxysulfide, a conductive additive, and a binder. An electrolyte includes a solvate ionic liquid.

In other features, the solid-state electrolyte comprises yLi₂S·(100-y-x)P₂S₅·xP₂O₅ where (y=70 to 80 mol %; x=1-10 mol %). The solvate ionic liquid is selected from a group consisting of Li[G3]TFSI, Li[G4]TFSI, Li[G3]FSI, Li[G4]FSI, Li[G3]BETI, Li[G4]BETI, Li[G3]CTFSI, Li[G4]CTFSI, Li[G3]ClO₄, Li[G4]ClO₄, Li[G3]BF₄, Li[G4]BF₄, and combinations thereof.

In other features, the binder is selected from a group consisting of styrene-butadiene rubber (SBR), hydrogenated nitrile rubber (HNBR), polyvinylidene difluoride (PVDF), poly(vinylidene difluoride-co-hexafluoropropylene) (PVDF-HFP), polytetrafluoroethylene (PTFE), poly(tetrafluoroethylene-co-perfluoro (3-oxa-4-pentenesulfonic acid)) lithium salt, polyacrylic acid (PAA), polyimide (PI), polyvinyl alcohol (PVA), carboxymethyl cellulose (CMC), and combinations thereof.

In other features, the anode active material layer comprises the anode active material in a range of 30 wt % to 70 wt %, the conductive additive in a range from 0.1 wt % to 20 wt %, the binder in a range from 0.1 wt % to 20 wt %, and the solid-state electrolyte in a range from 5 wt % to 20 wt %. The electrolyte further comprises a room temperature ionic liquid. The room temperature ionic liquid is selected from a group consisting of EMIM-TFSI, BMIM-TFSI, PYR13TFSI, PYR14TFSI, EMIM-FSI, BMIM-FSI, PYR13-FSI, PYR14-FSI, and combinations thereof.

In other features, the cathode active material layer comprises a cathode active material, a solid electrolyte comprising an oxysulfide, a conductive additive, and a binder. The cathode active material is selected from a group consisting of Li₂S₈, LiFePO₄, Li₂S₆, Li₂S₄, Li₂S₂, Li₂S, and combinations thereof. The conductive additive of the anode active material layer and the cathode active material layer is selected from a group consisting of carbon black, graphite, acetylene black, carbon nanotubes, carbon fibers, carbon nanofibers, graphene, graphene nanoplatelets, graphene oxide, nitrogen-doped carbon, metallic powder, a liquid metal, a conductive polymer, and combinations thereof.

A battery cell includes an enclosure and a battery cell stack including C cathode electrodes each comprising a cathode active material layer arranged on a cathode current collector. The cathode active material layer comprises a cathode active material including lithium-sulfur, a solid electrolyte comprising yLi₂S·(100-y-x)P₂S₅·xP₂O₅ where (y=70 to 80 mol %; x=1-10 mol %), a conductive additive, and a binder. The battery cell stack further includes S separators and A anode electrodes each comprising an anode active material layer arranged on an anode current collector, wherein A, C, and S are integers greater than one. The anode active material layer includes an anode active material selected from a group consisting of silicon, silicon oxide, silicon alloy, and tin. The anode active material layer includes a solid-state electrolyte including yLi₂S·(100-y-x)P₂S₅·xP₂O₅ where (y=70 to 80 mol %; x=1-10 mol %). The anode active material layer includes a conductive additive and a binder. An electrolyte includes a solvate ionic liquid.

In other features, the binder comprises hydrogenated nitrile rubber (HNBR). The binder is selected from a group consisting of styrene-butadiene rubber (SBR), hydrogenated nitrile rubber (HNBR), polyvinylidene difluoride (PVDF), poly(vinylidene difluoride-co-hexafluoropropylene) (PVDF-HFP), polytetrafluoroethylene (PTFE), poly(tetrafluoroethylene-co-perfluoro (3-oxa-4-pentenesulfonic acid)) lithium salt, polyacrylic acid (PAA), polyimide (PI), polyvinyl alcohol (PVA), carboxymethyl cellulose (CMC), and combinations thereof.

In other features, the solvate ionic liquid is selected from a group consisting of Li[G3]TFSI, Li[G4]TFSI, Li[G3]FSI, Li[G4]FSI, Li[G3]BETI, Li[G4]BETI, Li[G3]CTFSI, Li[G4]CTFSI, Li[G3]ClO₄, Li[G4]ClO₄, Li[G3]BF₄, Li[G4]BF₄, and combinations thereof. The anode active material layer comprises the anode active material in a range of 30 wt % to 70 wt %, the conductive additive in a range from 0.1 wt % to 20 wt %, the binder in a range from 0.1 wt % to 20 wt %, and the solid-state electrolyte in a range from 5 wt % to 20 wt %.

In other features, the electrolyte further comprises a room temperature ionic liquid selected from a group consisting of EMIM-TFSI, BMIM-TFSI, PYR13TFSI, PYR14TFSI, EMIM-FSI, BMIM-FSI, PYR13-FSI, PYR14-FSI, and combinations thereof. The cathode active material is selected from a group consisting of Li₂S₈, LiFePO₄, Li₂S₆, Li₂S₄, Li₂S₂, Li₂S, and combinations thereof.

In other features, the conductive additive of the anode active material layer and the cathode active material layer is selected from a group consisting of carbon black, graphite, acetylene black, carbon nanotubes, carbon fibers, carbon nanofibers, graphene, graphene nanoplatelets, graphene oxide, nitrogen-doped carbon, metallic powder, a liquid metal, a conductive polymer, and combinations thereof.

A battery cell includes an enclosure and a battery cell stack including C cathode electrodes each comprising a cathode active material layer arranged on a cathode current collector. The cathode active material layer comprises a cathode active material selected from a group consisting of Li₂S₈, LiFePO₄, Li₂S₆, Li₂S₄, Li₂S₂, Li₂S, and combinations thereof, a solid electrolyte comprising yLi₂S·(100-y-x)P₂S₅·xP₂O₅ where (y=70 to 80 mol %; x=1-10 mol %), a conductive additive, and a binder. The battery cell stack further includes S separators and A anode electrodes each comprising an anode active material layer arranged on an anode current collector, wherein A, C, and S are integers greater than one. The anode active material layer include an anode active material selected from a group consisting of silicon, silicon oxide, silicon alloy, and tin, the solid-state electrolyte, a conductive additive, and a binder comprising hydrogenated nitrile rubber (HNBR). An electrolyte includes a solvate ionic liquid.

In other features, the anode active material layer comprises the anode active material in a range of 30 wt % to 70 wt %, the conductive additive in a range from 0.1 wt % to 20 wt %, the binder in a range from 0.1 wt % to 20 wt %, and the solid-state electrolyte in a range from 5 wt % to 20 wt %.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a side cross-sectional view of an example of a battery cell including anode electrodes according to the present disclosure;

FIG. 2 is a side cross sectional view of a battery pack according to the present disclosure;

FIG. 3 is a side cross sectional view of an example of an anode electrode according to the present disclosure;

FIG. 4 is a graph illustrating an example of voltage as a function of lithiation capacity for a conventional anode electrode;

FIG. 5 is a graph illustrating an example of voltage as a function of lithiation capacity for an anode electrode according to the present disclosure; and

FIG. 6 is a graph illustrating an example of voltage as a function of lithiation capacity for a conventional anode electrode and an anode electrode according to the present disclosure.

In the drawings, reference numbers may be reused to identify similar and/or identical elements.

### DETAILED DESCRIPTION

While battery cells according to the present disclosure are described herein in the context of electric vehicles, the battery cells can be used in stationary applications and/or in other types of battery applications.

The present disclosure relates to battery cells including anode electrodes (e.g., with silicon (Si) as the anode active material) and cathode electrodes (e.g., with lithium-sulfur (Li—S) as the cathode active material). Battery cells using Li—S cathode active material and dimethoxyethane (DME) and dioxolane (DOL)-based liquid electrolyte (LE) typically require lithium nitrate (LiNO₃) to achieve adequate charge efficiency. However, battery cells using LiNO₃ experience excessive swelling due to vent gases produced during cycling. Furthermore, DME and DOL solvents are both volatile and flammable.

Solvate ionic liquid (SIL) electrolytes can be used to reduce flammability. SIL electrolytes do not require LiNOs and are less expensive than solvent-in-salt electrolytes. However, the use of SIL electrolytes is not compatible with conventional Si anode electrodes. Incorporating solid-state electrolyte (SSE) into the Si anode electrodes enhances performance by increasing anode ion transport and kinetics.

Anode electrodes according to the present disclosure include oxysulfide solid-state electrolyte. For example, when the solid-state electrolyte comprises yLi₂S·(100-y-x)P₂S₅·xP₂O₅ where (y=70 to 80 mol %; x=1-10 mol %) (or LPSO) and SIL, the first cycle lithiation capacity increases significantly (e.g., by 200x). In some examples, the lithiation capacity of the anode electrode is less than 15 mAh/g for conventional Si anodes as compared to greater than 3000 mAh/g when using oxysulfide SSE and SIL. Both wet process and dry process can be used to fabricate the anode and cathode electrodes, which enables high volume production techniques such as roll-to-roll processes.

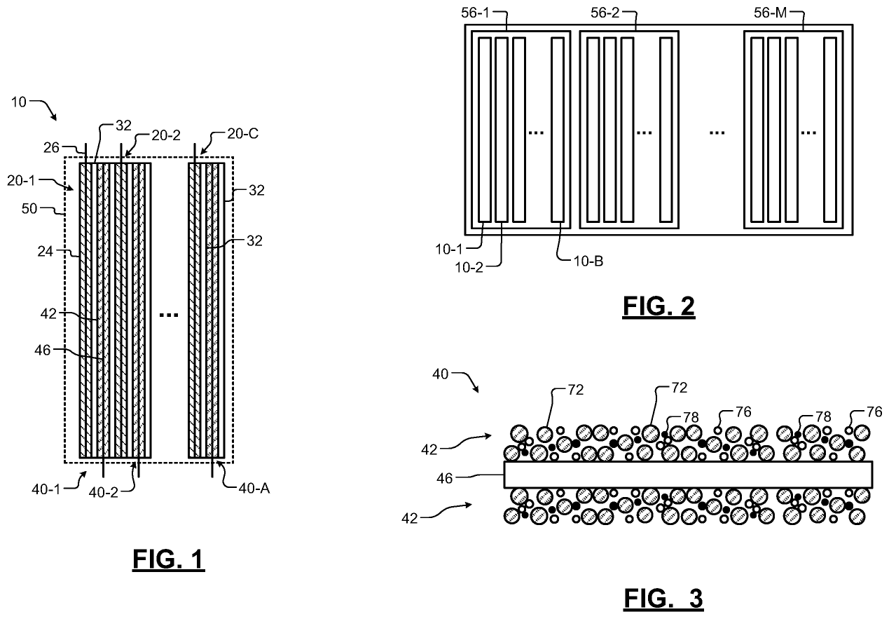

Referring now to FIGS. 1 and 2, a battery cell 10 includes C cathode electrodes 20-1, 20-2, . . . , and 20-C, where C is an integer greater than one. Each of the C cathode electrodes 20 includes a cathode active material layer 24 arranged on one or both sides of a cathode current collector 26. The battery cell 10 includes A anode electrodes 40-1, 40-2, . . . , and 40-A, where A is an integer greater than one. Each of the A anode electrodes 40 includes an anode active material layer 42 arranged on one or both sides of anode current collector 46.

The C cathode electrodes 20, the A anode electrodes 40 and S separators 32 are arranged in a predetermined order in an enclosure 50, where S is an integer greater than one. For example, the S separators 32 are arranged between adjacent pairs of the C cathode electrodes 20 and the A anode electrodes 40.

In some examples, the cathode current collectors 26 and/or the anode current collectors 46 comprise metal foil, metal mesh, and/or expanded metal. In some examples, the cathode current collectors 26 and/or the anode current collectors 46 are made of one or more materials selected from a group consisting of copper, stainless steel, brass, bronze, zinc, aluminum, and/or alloys thereof. External tabs 28 and 48 are connected to the current collectors of the cathode electrodes and anode electrodes, respectively, and can be arranged on the same side, different sides, or opposite sides of the battery cell stack 12. The external tabs 28 and 48 are connected to terminals of the battery cells.

In FIG. 2, a battery pack 58 includes M battery modules 56-1, 56-2, . . . , and 56-M each including B of the battery cells 10 (e.g., battery cells 10-1, 10-2, . . . , and 10-B), where B and M are integers greater than one.

Referring now to FIG. 3, the anode electrode 40 includes the anode active material layer 42 arranged on one or both sides of the anode current collector 46. The anode active material layer 42 includes a mixture of an anode active material 72 (e.g., Si), a solid state electrolyte (SSE) 76 (e.g., LPSO), a conductive filler 78 (e.g., conductive carbon), and a binder (e.g., hydrogenated nitrile butadiene rubber (HBNR)) (not shown).

In some examples, the anode active material is selected from a group consisting of silicon (Si), silicon oxide (SiOₓ), Si alloy, tin (Sn), and/or other suitable anode active materials. In some examples, the binder is selected from a group consisting of styrene-butadiene rubber (SBR), hydrogenated nitrile rubber (HNBR), polyvinylidene difluoride (PVDF), poly(vinylidene difluoride-co-hexafluoropropylene) (PVDF-HFP), polytetrafluoroethylene (PTFE), poly(tetrafluoroethylene-co-perfluoro (3-oxa-4-pentenesulfonic acid)) lithium salt, polyacrylic acid (PAA), polyimide (PI), polyvinyl alcohol (PVA), carboxymethyl cellulose (CMC) and combinations thereof.

In some examples, the anode active material comprises 30 wt. % to 70 wt. % of the anode active material layer. The conductive carbon comprises 0.1 wt. % to 20 wt. % of the anode active material layer. The binder comprises 0.1 wt. % to 20 wt. % of the anode active material layer. The solid-state electrolyte comprises 5 wt. % to 50 wt. % of the anode active material layer. The SIL electrolyte comprises 0.1 wt. % to 50 wt. % of the anode active material layer after the SIL electrolyte is added to the battery enclosure.

In other examples, the SSE comprises 5 wt. % to 20 wt. % of the anode active material layer. In other examples, the SIL electrolyte comprises 20 wt. % to 50 wt. % of the anode active material layer after the SIL electrolyte is added to the enclosure. In some examples, the anode electrode has an areal capacity of 1 to 5 mAh/cm². In some examples, the anode active material layer has a porosity of 10% to 60%.

In some examples, the SSE includes an oxysulfide. In some examples, the SSE includes yLi₂S·(100-y-x)P₂S₅·xP₂O₅ where (y=70 to 80 mol %; x=1-10 mol %) (LPSO). In some examples, the SIL electrolyte is selected from a group consisting of Li[G3]TFSI, Li[G4]TFSI, Li[G3]FSI, Li[G4]FSI, Li[G3]BETI, Li[G4]BETI, Li[G3]CTFSI, Li[G4]CTFSI, Li[G3]ClO₄, Li[G4]ClO₄, Li[G3]BF₄, Li[G4]BF₄, and combinations thereof. In some examples, the SIL electrolyte may further comprise one or more diluents. Examples of diluents include triethyl phosphate, 1,1,2,2-Tetrafluoroethyl-2,2,3,3-tetrafluoropropyl ether, dibasic ester, dipropylene glycol monoethyl ether, and combinations thereof.

In some examples, the conductive filler is selected from a group consisting of carbon black, graphite, acetylene black, carbon nanotubes, carbon fibers, carbon nanofibers, graphene, graphene nanoplatelets, graphene oxide, nitrogen-doped carbon, metallic powder, a liquid metal, a conductive polymer, and combinations thereof.

In some examples, the battery cell further includes a room temperature ionic liquid (RTIL) electrolyte. In some examples, the RTIL is selected from a group consisting of EMIM-TFSI, BMIM-TFSI, PYR13TFSI, PYR14TFSI, EMIM-FSI, BMIM-FSI, PYR13-FSI, PYR14-FSI, and combinations thereof.

In some examples, the cathode active material layer of the cathode electrodes includes a cathode active material, a solid-state electrolyte, a binder, and a conductive additive. In some examples, the solid-state electrolyte of the cathode active material layer comprises an oxysulfide. In some examples, the solid-state electrolyte comprises yLi₂S·(100-y-x)P₂S₅·xP₂O₅ where (y=70 to 80 mol %; x=1-10 mol %). In some examples, the cathode active material includes lithium sulfide selected from a group consisting of Li₂S₈, LiFePO₄, Li₂S₆, Li₂S₄, Li₂S₂, Li₂S, and combinations thereof.

In some examples, the conductive additive of the cathode active material layer is selected from a group consisting of carbon black, graphite, acetylene black, carbon nanotubes, carbon fibers, carbon nanofibers, graphene, graphene nanoplatelets, graphene oxide, nitrogen-doped carbon, metallic powder, a liquid metal, a conductive polymer, and combinations thereof.

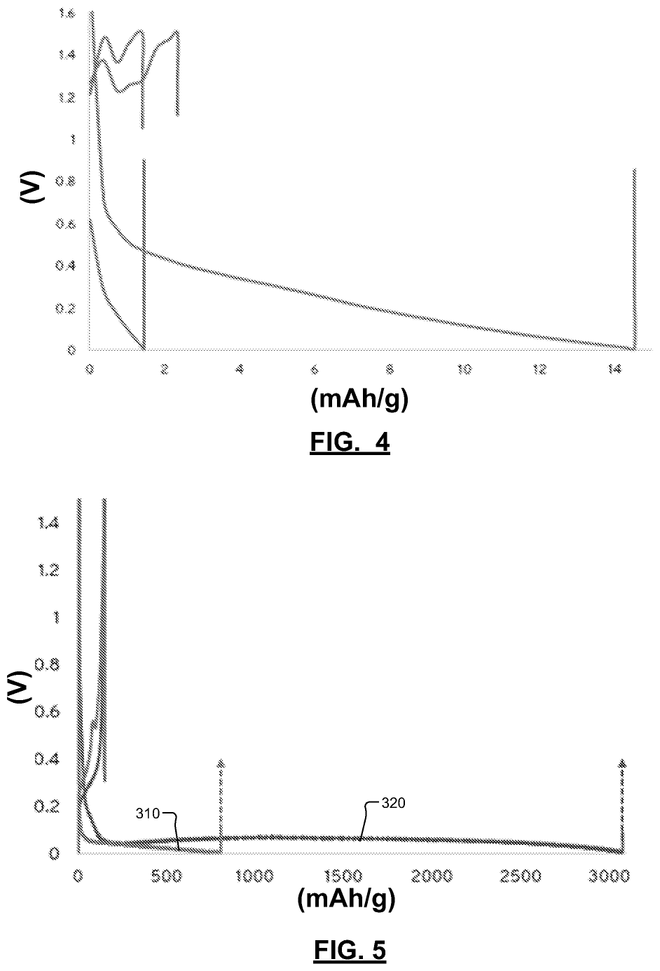

Referring now to FIGS. 4 and 5, voltage is shown as a function of capacity for examples of a conventional anode electrode and an anode electrode according to the present disclosure, respectively. In FIG. 4, a conventional anode electrode includes active material (e.g., 80 wt % silicon), a conductive additive (e.g., 10 wt % graphene nanoplatelets), and a binder (e.g., 10 wt % polyacrylic acid) in a solvate ionic liquid (e.g., Li[G3]TFSI). The lithiation capacity is very low (e.g., less than 15 mAh/g).

In FIG. 5, a first example of an anode electrode at 310 includes anode active material (e.g., 60 wt % silicon), a conductive additive (e.g., 10 wt % Super P), a solid-state electrolyte (20 wt % LPSO), and a binder (e.g., 10 wt % polyacrylic acid) in a solvate ionic liquid. The lithiation capacity is higher (e.g., ˜ 800 mAh/g). A second example of an anode electrode at 320 includes active material (e.g., 60 wt % silicon), a conductive additive (e.g., 10 wt % Super P), a solid-state electrolyte (20 wt % LPSO), and a binder (e.g., 10 wt % HNBR) in a solvate ionic liquid. The lithiation capacity is much higher (e.g., ˜ 3000 mAh/g).

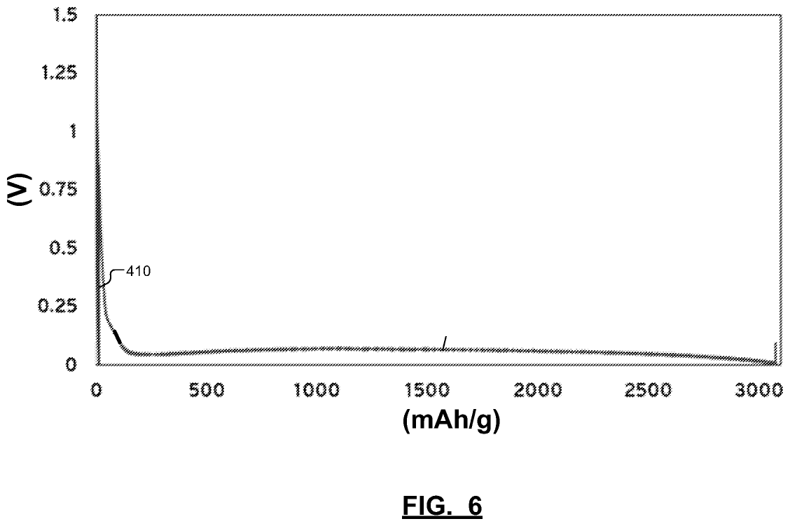

Referring now to FIG. 6, lithiation capacity of a conventional battery cell including an anode electrode with silicon active material, polyacrylic acid (PAA), and graphite nanoplatelets (GNP) in Li[G3]TFSI at 410 is compared to a battery cell including an anode electrode according to the present disclosure at 420. In this example, the anode electrode according to the present disclosure includes active material including silicon, a solid-state electrolyte including LPSO, a binder including HBNR, and a conductive additive including Super P (G3). In this example, the lithiation capacity of the conventional battery cell is less than 15 mAh/g while the lithiation capacity of the battery cell including the anode electrode according to the present disclosure is 3077 mAh/g.

In some examples, a wet process is used to manufacture the battery cells. The anode active material is mixed with the binder, the solid-state electrolyte, and the conductive additive in a solvent (e.g., toluene) to form a slurry. The slurry is cast onto an anode current collector (such as copper) and dried. In some examples, the solvent is selected from a group consisting of toluene, cyclohexane, alkane, anisole, organic phosphate, dioxolane, 1,4 dioxane, tetrahydrofuran (THF), ethyl propionate, ethane-1,2-dithiol (EDT), and combinations thereof. In some examples, the anode electrode is manufactured using a roll-to-roll process.

In other examples, the anode electrode is manufactured using a dry process. The active material is mixed with the binder, the SSE, and the conductive carbon without solvent. In some examples, the dry mixing method includes double blade milling, ball milling, and/or a circulating blending hybridizer. The anode current collector is coated using Maxwell-type, dry spraying, hot pressing, melting extrusion, and/or 3D printing. Then, the anode electrode is calendared (e.g., pressed between a roller at a pressure in a range from 20-500 MPa).

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

What is claimed is:

1. A battery cell comprising:
an enclosure;
a battery cell stack comprising:
C cathode electrodes each comprising a cathode active material layer arranged on a cathode current collector;
S separators;
A anode electrodes each comprising an anode active material layer arranged on an anode current collector, wherein A, C, and S are integers greater than one,
wherein the anode active material layer comprises:
an anode active material selected from a group consisting of silicon, silicon oxide, silicon alloy, and tin;
a solid-state electrolyte comprising an oxysulfide;
a conductive additive; and
a binder; and
an electrolyte comprising a solvate ionic liquid.

2. The battery cell of claim 1, wherein the solid-state electrolyte comprises yLi₂S·(100-y-x) P₂S₅·xP₂O₅ where (y=70 to 80 mol %; x=1-10 mol %).

3. The battery cell of claim 1, wherein the solvate ionic liquid is selected from a group consisting of Li[G3]TFSI, Li[G4]TFSI, Li[G3]FSI, Li[G4]FSI, Li[G3]BETI, Li[G4]BETI, Li[G3]CTFSI, Li[G4]CTFSI, Li[G3]ClO₄, Li[G4]ClO₄, Li[G3]BF₄, Li[G4]BF₄, and combinations thereof.

4. The battery cell of claim 1, wherein the binder is selected from a group consisting of styrene-butadiene rubber (SBR), hydrogenated nitrile rubber (HNBR), polyvinylidene difluoride (PVDF), poly(vinylidene difluoride-co-hexafluoropropylene) (PVDF-HFP), polytetrafluoroethylene (PTFE), poly(tetrafluoroethylene-co-perfluoro (3-oxa-4-pentenesulfonic acid)) lithium salt, polyacrylic acid (PAA), polyimide (PI), polyvinyl alcohol (PVA), carboxymethyl cellulose (CMC), and combinations thereof.

5. The battery cell of claim 1, wherein the anode active material layer comprises the anode active material in a range of 30 wt % to 70 wt %, the conductive additive in a range from 0.1 wt % to 20 wt %, the binder in a range from 0.1 wt % to 20 wt %, and the solid-state electrolyte in a range from 5 wt % to 20 wt %.

6. The battery cell of claim 1, wherein the electrolyte further comprises a room temperature ionic liquid.

7. The battery cell of claim 6, wherein the room temperature ionic liquid is selected from a group consisting of EMIM-TFSI, BMIM-TFSI, PYR13TFSI, PYR14TFSI, EMIM-FSI, BMIM-FSI, PYR13-FSI, PYR14-FSI, and combinations thereof.

8. The battery cell of claim 1, wherein the cathode active material layer comprises a cathode active material, a solid electrolyte comprising an oxysulfide, a conductive additive, and a binder.

9. The battery cell of claim 8, wherein the cathode active material is selected from a group consisting of Li₂S₈, LiFePO₄, Li₂S₆, Li₂S₄, Li₂S₂, Li₂S, and combinations thereof.

10. The battery cell of claim 8, wherein the conductive additive of the anode active material layer and the cathode active material layer is selected from a group consisting of carbon black, graphite, acetylene black, carbon nanotubes, carbon fibers, carbon nanofibers, graphene, graphene nanoplatelets, graphene oxide, nitrogen-doped carbon, metallic powder, a liquid metal, a conductive polymer, and combinations thereof.

11. A battery cell comprising:
an enclosure;
a battery cell stack comprising:
C cathode electrodes each comprising a cathode active material layer arranged on a cathode current collector,
wherein the cathode active material layer comprises a cathode active material including lithium-sulfur, a solid electrolyte comprising yLi₂S·(100-y-x)P₂S₅·xP₂O₅ where (y=70 to 80 mol %; x=1-10 mol %), a conductive additive, and a binder;
S separators;
A anode electrodes each comprising an anode active material layer arranged on an anode current collector, wherein A, C, and S are integers greater than one,
wherein the anode active material layer comprises:
an anode active material selected from a group consisting of silicon, silicon oxide, silicon alloy, and tin;
a solid-state electrolyte comprising yLi₂S·(100-y-x)P₂S₅·xP₂O₅ where (y=70 to 80 mol %; x=1-10 mol %);
a conductive additive; and
a binder; and
an electrolyte comprising a solvate ionic liquid.

12. The battery cell of claim 11, wherein the binder comprises hydrogenated nitrile rubber (HNBR).

13. The battery cell of claim 11, wherein the binder is selected from a group consisting of styrene-butadiene rubber (SBR), hydrogenated nitrile rubber (HNBR), polyvinylidene difluoride (PVDF), poly(vinylidene difluoride-co-hexafluoropropylene) (PVDF-HFP), polytetrafluoroethylene (PTFE), poly(tetrafluoroethylene-co-perfluoro (3-oxa-4-pentenesulfonic acid)) lithium salt, polyacrylic acid (PAA), polyimide (PI), polyvinyl alcohol (PVA), carboxymethyl cellulose (CMC), and combinations thereof.

14. The battery cell of claim 11, wherein the solvate ionic liquid is selected from a group consisting of Li[G3]TFSI, Li[G4]TFSI, Li[G3]FSI, Li[G4]FSI, Li[G3]BETI, Li[G4]BETI, Li[G3]CTFSI, Li[G4]CTFSI, Li[G3]ClO₄, Li[G4]ClO₄, Li[G3]BF₄, Li[G4]BF₄, and combinations thereof.

15. The battery cell of claim 11, wherein the anode active material layer comprises the anode active material in a range of 30 wt % to 70 wt %, the conductive additive in a range from 0.1 wt % to 20 wt %, the binder in a range from 0.1 wt % to 20 wt %, and the solid-state electrolyte in a range from 5 wt % to 20 wt %.

16. The battery cell of claim 11, wherein the electrolyte further comprises a room temperature ionic liquid selected from a group consisting of EMIM-TFSI, BMIM-TFSI, PYR13TFSI, PYR14TFSI, EMIM-FSI, BMIM-FSI, PYR13-FSI, PYR14-FSI, and combinations thereof.

17. The battery cell of claim 11, wherein the cathode active material is selected from a group consisting of Li₂S₈, LiFePO₄, Li₂S₆, Li₂S₄, Li₂S₂, Li₂S, and combinations thereof.

18. The battery cell of claim 11, wherein the conductive additive of the anode active material layer and the cathode active material layer is selected from a group consisting of carbon black, graphite, acetylene black, carbon nanotubes, carbon fibers, carbon nanofibers, graphene, graphene nanoplatelets, graphene oxide, nitrogen-doped carbon, metallic powder, a liquid metal, a conductive polymer, and combinations thereof.

19. A battery cell comprising:
an enclosure;
a battery cell stack comprising:
C cathode electrodes each comprising a cathode active material layer arranged on a cathode current collector, wherein the cathode active material layer comprises a cathode active material selected from a group consisting of Li₂S₈, LiFePO₄, Li₂S₆, Li₂S₄, Li₂S₂, Li₂S, and combinations thereof, a solid-state electrolyte comprising yLi₂S·(100-y-x)P₂S₅·xP₂O₅ where (y=70 to 80 mol %; x=1-10 mol %), a conductive additive, and a binder;
S separators; and
A anode electrodes each comprising an anode active material layer arranged on an anode current collector, wherein A, C, and S are integers greater than one,
wherein the anode active material layer comprises an anode active material selected from a group consisting of silicon, silicon oxide, silicon alloy, and tin, the solid-state electrolyte, a conductive additive, and a binder comprising hydrogenated nitrile rubber (HNBR); and
an electrolyte comprising a solvate ionic liquid.

20. The battery cell of claim 19, wherein the anode active material layer comprises the anode active material in a range of 30 wt % to 70 wt %, the conductive additive in a range from 0.1 wt % to 20 wt %, the binder in a range from 0.1 wt % to 20 wt %, and the solid-state electrolyte in a range from 5 wt % to 20 wt %.
